(19) United States
(12) Patent Application Publication
(10) Pub. No.: US 2015/0004035 A1
(43) Pub. Date: Jan. 1, 2015

(54) APPARATUSES AND METHODS FOR ACTUATING VALVES

(71) Applicant: NUOVO PIGNONE S.p.A., Florence (IT)

(72) Inventors: Riccardo Bagagli, Florence (IT); Leonardo Tognarelli, Florence (IT)

(21) Appl. No.: 14/369,163

(22) PCT Filed: Dec. 17, 2012
(86) PCT No.: PCT/EP2012/075727

§ 371 Date: Jun. 26, 2014

(30) Foreign Application Priority Data
Dec. 27, 2011 (IT) MI2011A002392

(51) Int. Cl. F16K 31/52; F04B 39/14; F04B 53/10

(52) U.S. Cl. CPC F16K 31/52; F04B 53/10; F04B 39/14
USPC 417/510; 251/279; 29/888.021

(57) ABSTRACT

A valve assembly including an actuator configured to provide a displacement, a shaft configured to transmit the displacement from the actuator to a valve closing member of a valve of the reciprocating compressor, and a displacement transmission mechanism connected to the shaft, and configured to amplify the displacement and/or a force associated with the displacement provided by the actuator to actuate the valve closing member of the valve.

### BACKGROUND

1. Technical Field

Embodiments of the subject matter disclosed herein generally relate to apparatuses and methods for actuating valves used in reciprocating compressors in oil and gas industry, and, more particularly, to devices and methods for amplifying a displacement and/or a force associated with the displacement, between an actuator and the actuated valve.

2. Discussion of the Background

Compressors are mechanical devices that increase the pressure of a gas and can be found in engines, turbines, power generation, cryogenic applications, oil and gas processing, etc. Due to their widespread use, various mechanisms and techniques related to compressors are often the subject to research for improving the compressor efficiency and solving problems related to specific operating environments. One particularity that has to be considered for compressors used in oil and gas industry is that the compressed fluid is frequently corrosive and combustible. American Petroleum Institute (API), the organization setting the recognized industry standard for equipment used in oil and gas industry has issued a document, API618 (whose version as of June 2011 is included herewith by reference), listing a complete set of minimum requirements for reciprocating compressors.

The compressors may be classified as positive displacement compressors (e.g., reciprocating, screw, or vane compressors) or dynamic compressors (e.g., centrifugal or axial compressors). In the positive displacement compressors, the gas is compressed by trapping the gas in a chamber and then reducing the volume of that chamber. In the dynamic compressors, the gas is compressed by transferring the kinetic energy typically from a rotating element such as an impeller to the gas to be compressed by the compressor.

FIG. 1 is an illustration of a conventional dual chamber reciprocating compressor 10 (i.e., a positive displacement compressor), which is used in oil and gas industry. The compression occurs in a cylinder 20. A fluid to be compressed (e.g., natural gas) is input into the cylinder 20 via an inlet 30 and through valves 32, 34, and, after the compression, it is output via valves 42 and 44 and then an outlet 40. The compressor operates in a cyclical process during which the fluid is compressed due to a movement of the piston 50 in the cylinder 20, between a head end 26 and a crank end 28. The piston 50 divides the cylinder 20 in two chambers 22 and 24 operating in different phases of the cyclical process, the volume of chamber 22 being at its lowest value when the volume of the chamber 24 is at its highest value and vice-versa.

Suction valves 32 and 34 open at different times to allow the fluid that is going to be compressed (i.e., having a first/suction pressure P₁) from the inlet 30 into the chambers 22 and 24, respectively. Discharge valves 42 and 44 open to allow the fluid that has been compressed (i.e., having a second/discharge pressure P₂) to be output from the chambers 22 and 24, respectively, via the outlet 40. The piston 50 moves due to energy transmitted from a crankshaft 60 via a crosshead 70 and a piston rod 80. Conventionally, the suction and the discharge valves (e.g., 32, 34, 42, and 44) used in a reciprocating compressor are automatic valves that are switched between a close state and an open state due to a differential pressure across the valve.

The typical compression cycle includes four phases: expansion, suction, compression and discharge. When the compressed fluid is evacuated from a chamber at the end of a compression cycle, a small amount of fluid at the delivery pressure P₂ remains trapped in a clearance volume (i.e., the minimum volume of the chamber). During the expansion phase and the suction phase of the compression cycle, the piston moves to increase the volume of the chamber. At the beginning of the expansion phase, the delivery valve closes (the suction valve remaining closed), and then, the pressure of the trapped fluid drops since the volume of the chamber available to the fluid increases. The suction phase of the compression cycle begins when the pressure inside the chamber becomes equal to the suction pressure p₁, triggering the suction valve to open. During the suction phase, the chamber volume and the amount of fluid to be compressed (at the pressure p₁) increase until a maxim volume of the chamber is reached.

During the compression and discharge phases of the compression cycle, the piston moves in a direction opposite to the direction of motion during the expansion and compression phases, to decrease the volume of the chamber. During the compression phase both the suction and the delivery valves are closed (i.e. the fluid does not enter or exits the cylinder), the pressure of the fluid in the chamber increasing (from the suction pressure P₁ to the delivery pressure P₂) because the volume of the chamber decreases. The delivery phase of the compression cycle begins when the pressure inside the chamber becomes equal to the delivery pressure p₂, triggering the delivery valve to open. During the delivery phase the fluid at the delivery pressure p₂ is evacuated from the chamber until the minimum (clearance) volume of the chamber is reached.

FIG. 2 graphically illustrates in a pressure versus volume coordinate system, for the compression cycles taking place in chamber 22 (the continuous line) and for the compression cycles taking place in chamber 24 (the dashed line), respectively. In the graph, the volume V_{c1} of chamber 22 increases from left to right while volume V_{c1} of the chamber 24 increases from right to left. The expansion phase corresponds to 1-2 and 1′-2′, respectively, the suction phase corresponds to 2-3 and 2′-3′, the compression phase corresponds to 3-4 and 3′-4′, and the discharge phase corresponds to 4-1 and 4′-1′.

Potential advantages for increasing the efficiency and reducing the clearance volume for the reciprocating compressors used in oil and gas industry are expected if actuated valves would be used instead of automated valves. However, the use of actuated valves has not yet been developed due to the special technical requirements of operating reciprocating compressors in the oil and gas industry. None of the currently available actuators can provide the larger forces, larger displacements and shorter response times required simultaneously. Additionally, in oil and gas industry, an aspect further constrains the use of actuated valves in reciprocating compressors is that the fluid is inflammable and an explosion would damage the compressor.

In contrast, actuating valves in automotive industry (most frequently done using electric actuators) may require a large force and a short response time, but not a large displacement. Additionally, in the automotive industry equipment, there is no concern about explosions, the explosions being actually a sought after phenomenon, and the high pressure occurring due to explosions being easily dissipated in the ambient.

Further in contrast to the equipment in oil and gas industry, actuating valves in naval equipment (most frequently done with pneumatic or hydraulic actuators) requires large forces and may require large displacements, but the actuation time is not critical.

Accordingly, it would be desirable to provide valve assemblies and methods making it possible to use actuated valves in reciprocating compressors used in oil and gas industry.

### SUMMARY

Various embodiments of the current inventive concept set forth apparatuses and methods overcoming the technical challenges in actuating valves of reciprocating compressors used in oil and gas industry.

According to one exemplary embodiment, a valve assembly useable in a reciprocating compressor for oil and gas industry includes an actuator configured to provide a displacement, a shaft connected to the actuator and configured to transmit the displacement from the actuator to a valve closing member of a valve of the reciprocating compressor, and a displacement transmission mechanism connected to the shaft, and configured to amplify the displacement and/or a force associated with the displacement provided by the actuator.

According to another exemplary embodiment, a reciprocating compressor used in oil and gas industry has (1) a compressor body inside which a fluid is compressed to increase its pressure, (2) at least one valve connected to the compressor body and configured to switch between a close state in which the fluid is not allowed to flow through the valve and an open state in which the fluid is allowed to flow through the valve, depending on a position of a valve closing member of the valve, and (3) a valve assembly connected to the at least one valve. The valve assembly includes (A) an actuator configured to provide a displacement, (B) a shaft configured to transmit the displacement from the actuator to a valve closing member of a valve of the reciprocating compressor and (C) a displacement transmission mechanism connected to the shaft, and configured to amplify the displacement and/or a force associated with the displacement, to actuate the valve closing member of the valve.

According to another exemplary embodiment, a method of retrofitting a reciprocating compressor used in oil and gas industry and initially having an automatic valve is provided. The method includes (1) mounting an actuator configured to provide a displacement, outside a fluid path in the reciprocating compressor, (2) mounting a shaft connected to the actuator and configured to receive the displacement, to penetrate inside the fluid path in reciprocating compressor and to connect to a valve closing member of the valve, and (3) connecting a displacement transmission mechanism between the actuator and the valve closing member of the automatic valve, the displacement transmission mechanism being configured to amplify the displacement and/or a force associated with the displacement, when the displacement is transmitted via the shaft to actuate the valve closing member of the valve.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional dual chamber reciprocating compressor;

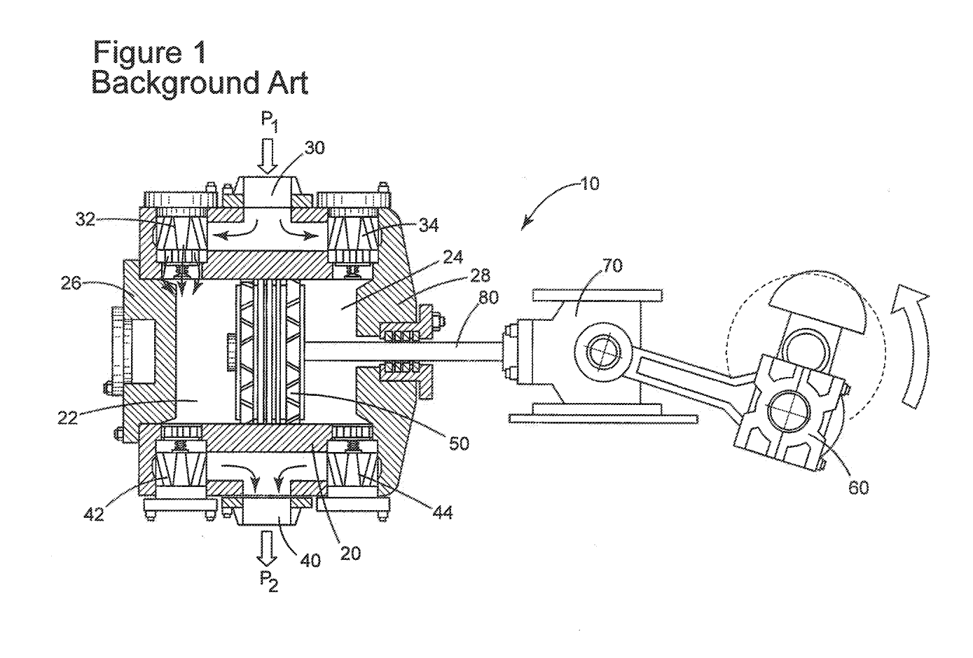

FIG. 2 is a graph illustrating a typical compression cycle;

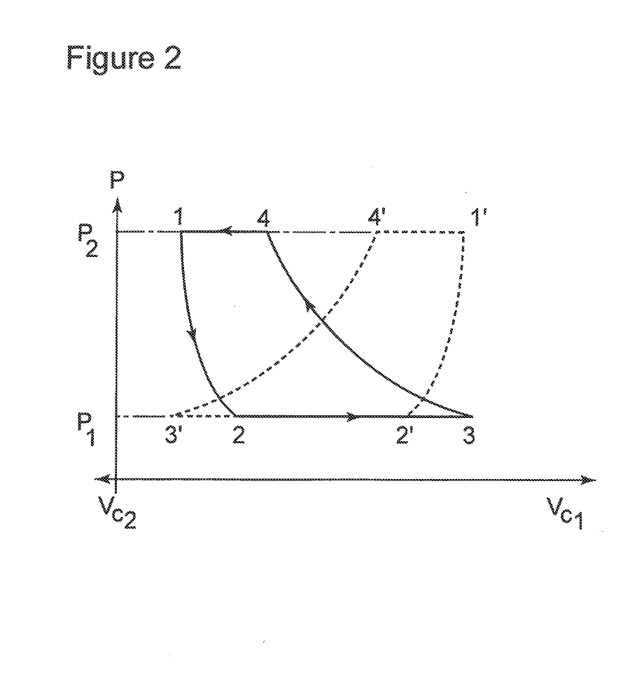

FIG. 3 is a reciprocating compressor according to an exemplary embodiment;

FIG. 4 is a schematic diagram of a valve assembly according to an exemplary embodiment;

FIG. 5 is a schematic diagram of a valve assembly according to another exemplary embodiment;

FIG. 6 is a schematic diagram of a valve assembly according to another exemplary embodiment;

FIG. 7 is a schematic diagram of a valve assembly according to another exemplary embodiment;

FIG. 8 is a schematic diagram of a valve assembly according to another exemplary embodiment;

FIG. 9 is a schematic diagram of a valve assembly according to another exemplary embodiment;

FIG. 10 is a schematic diagram of a valve assembly according to another exemplary embodiment; and

FIG. 11 is a flow chart illustrating a method for retrofitting a reciprocating compressor used in oil and gas industry according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of reciprocating compressors used in oil and gas industry. However, the embodiments to be discussed next are not limited to these systems, but may be applied to other systems.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

One objective of embodiments described hereinafter is to provide apparatuses (i.e., valve assemblies) and methods that would enable using one or more actuated valves in reciprocating compressors. The actuated valves may be linear (translating) valves or rotary (rotating) valves. The actuators may be linear actuators providing a linear displacement or rotating actuators providing an angular displacement. The (one or more) actuators, which are configured and connected to operate valve closing parts of the (one or more) valves, are, in an embodiment, mounted outside the body of the reciprocating compressors, so that the actuators are not in direct contact with the inflammable fluid.

Currently pneumatic, hydraulic and electric actuators are commercially available. The hydraulic and pneumatic actuators may be capable to deliver the force level necessary, but the time of delivering the force and the displacement far exceeds the short time required to actuate valves in reciprocating compressors used in oil and gas industry. The electric actuators may operate in the required response time, but do not provide enough force and/or displacement (e.g., they typically provide only 1-2 mm linear displacement or up to 40° angular displacement). Therefore, various valve assemblies described hereinafter according to exemplary embodiments amplify displacement and/or the force provided by an actuator to a valve of a reciprocating compressor used in oil and gas industry. By amplify the displacement and/or the force, it becomes possible to use currently available actuators is the reciprocating compressor used in oil and gas industry.

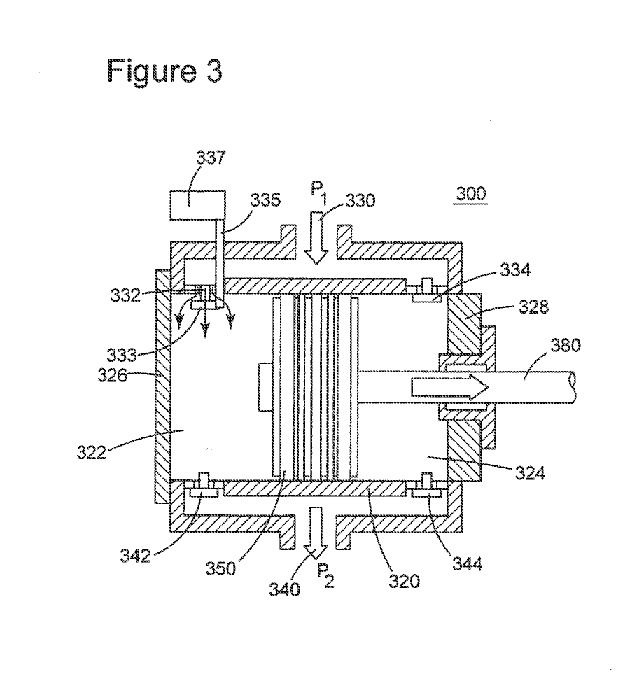

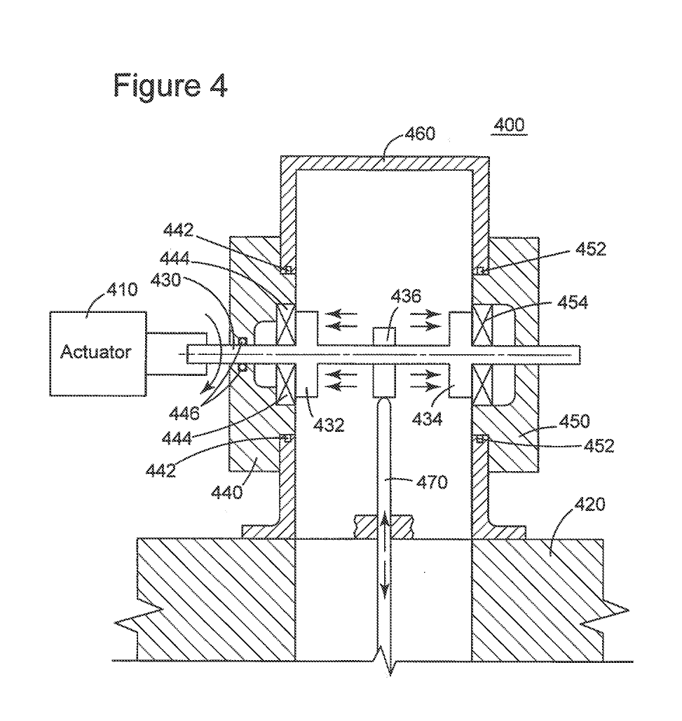

An exemplary embodiment of a reciprocating compressor 300 having an actuated valve 332 is schematically illustrated in FIG. 3. The compressor 300 is a dual chamber reciprocating compressor. However, valve assemblies according to embodiments similar to the ones illustrated in FIGS. 4-10 may be used also in single chamber reciprocating compressors. The compression occurs in chambers 322 and 324 of a cylinder 320. A fluid to be compressed (e.g., natural gas) is input into the cylinder 320 via an inlet 330, and, after the compression, is output via an outlet 340. The volumes of the chamber 322 and 324 is modified due to the movement of the piston 350 along the longitudinal axis of the cylinder 320, alternating between moving towards a head end 326 and towards a crank end 328. The piston 350 divides the cylinder 320 in two chambers 322 and 324 operating in different phases of the cyclic process, the volume of chamber 322 being at its lowest value when the volume of the chamber 324 is at its highest value and vice-versa.

Suction valves 332 and 334 open to allow the fluid that is going to be compressed (i.e., having a first pressure P₁) from the inlet 330 into the chambers 322 and 324, respectively. Discharge valves 342 and 344 open to allow the fluid that has been compressed (i.e., having a second pressure P₂) to be output from the chambers 322 and 324, respectively, via the outlet 340. The piston 350 moves due to energy received for example from a crankshaft (not shown) via a crosshead (not shown) and a piston rod 380. In FIG. 3, the valves 332, 334, 342, and 344 are illustrated as being located on a lateral wall of the cylinder 320. However, the valves 332 and 342, 334 and 344, may be located on the head end 326 and/or the crank end 328 of the cylinder 320, respectively.

In contrast to an automatic valve, which is opened depending on a differential pressure on opposite sides of a valve closing member of the valve, an actuated valve, such as 332 in FIG. 3, opens when an actuator, such as 337 in FIG. 3, applies a force transmitted via a valve-actuator coupling mechanism 335 to a valve closing member 333 of the valve 332, thereby inducing a linear or an angular displacement of the valve closing member 333. Actuated valves are more reliable than automatic valves and provide advantages for increasing the efficiency and reducing the clearance volume for the reciprocating compressors used in oil and gas industry. One or more valves of the reciprocating compressor 300 may be actuated valves. A combination of actuated valves and automatic valves may also occur in some embodiments; for example, the suction valves may be actuated while the discharge valves may be automatic valves.

FIG. 4 is a schematic representation of a valve assembly 400, according to an exemplary embodiment. An actuator 410 located outside a compressor body 420, is configured to provide an angular displacement to a shaft 430 penetrating inside the compressor body 420.

The shaft 430 has collars 432 and 434 close to cover shaft supports 440 and 450, respectively. At least one of the collars 432 and 434 may be removable, to facilitate installation of the shaft 430 (i.e., the shaft 430 and the collars 432 and 434 are not formed as one piece). The cover supports 440 and 450 together with a cover 460 are assembled to house and support the valve assembly 400. Static seals 442 and 452 located between the cover supports 440 and 450, respectively and the cover 460 ensure that the high pressure fluid inside the compressor does not leak outside thereof. These static seals may be O-rings.

A thrust bearing 444 located between the collar 432 and the cover shaft support 440 and a thrust bearing 454 located between the collar 434 and the cover support 450 are configured to remove the force (see the arrows pointing from inside towards outside) due to the pressure difference between the fluid (e.g., natural gas) inside of the compressor body and t he ambient outside the compressor body, where the actuator 410 is located. Other types of bearings different from thrust bearings may be used. Dynamic seals 446 located between the shaft 430 and the cover 460 ensure that the high pressure fluid inside the compressor does not leak outside thereof. These dynamic seals may be labyrinth seals.

A cam 436 is fixed to the shaft 430 (for rotation with the shaft), between the collars 432 and 434. The cam 436 has an asymmetric shape relative to the rotation axis of the shaft 430. The cam 436 is configured to be in contact with an actuator shaft 470, which is connected to a valve closing member (not shown) of a linear valve (e.g., a popper valve or a ring valve). Due to the shape of the cam 436, a rotation displacement transmitted by the actuator 410 to the shaft 430 is converted into a linear displacement of the valve closing member.

Thus, due to the cam 436, the assembly 400 may be used to amplify and convert an angular displacement provided by an electric actuator (e.g., up to 40°) into a linear displacement as needed (e.g., 5-10 mm) to actuate a valve in a reciprocating compressor.

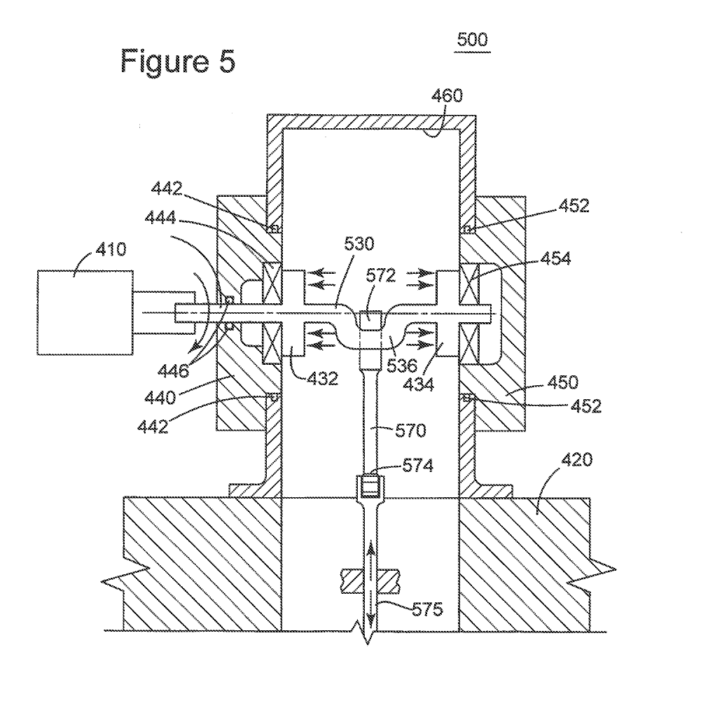

FIG. 5 is a schematic representation of a valve assembly 500, according to another exemplary embodiment. Some components of the valve assembly 500 are similar to components of the valve assembly 400 in FIG. 4 and, therefore, have the same labels and are not described again to avoid repetition. However, even the similar components may have substantially different characteristics. The actuator 410 located outside the compressor body 420, is configured to provide an angular displacement to a shaft 530 penetrating inside the compressor body 420. The shaft 530 has collars 532 and 534 close to the cover shaft supports 440 and 450. The cover supports 440 and 450 together with the cover 460 are assembled to house and support the valve assembly 500.

The shaft 530 is configured to have a portion 536 substantially parallel to a rotation axis of the shaft, but at a predetermined significant (i.e., visible, affecting motion of parts attached to this portion) distance from the axis. A connecting rod 570 is attached to the portion 536. An end 572 of the connecting rod 570 towards the portion 536 rotates with the portion 536, while the opposite end 574 connected to an actuator shaft 575 has a linear displacement. The linear displacement is transmitted to the valve's valve closing member (not shown) via the actuator shaft 575.

Thus, due to the shape of the shaft 530 and the connecting rod 570, a relatively small angular displacement of the shaft caused by the actuator 410 is converted into a substantial linear displacement of the valve closing member.

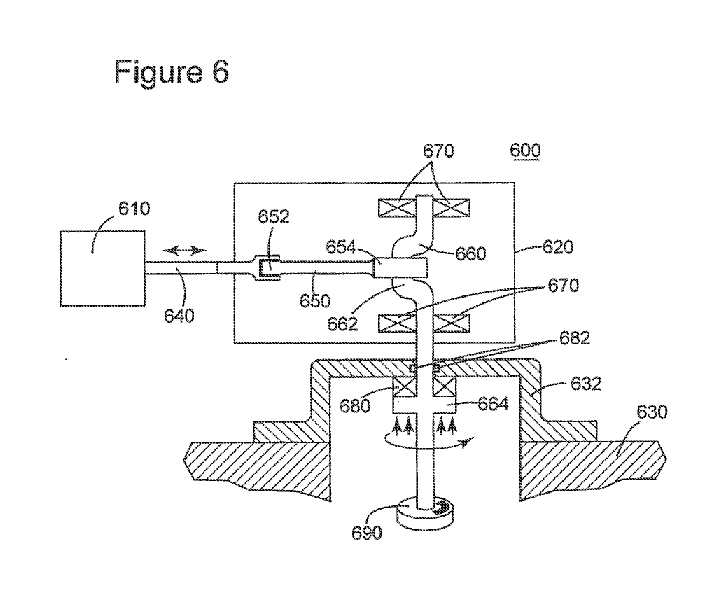

FIG. 6 is a schematic representation of a valve assembly 600, according to another exemplary embodiment. In the valve assembly 600, a linear displacement generated by an actuator 610 is converted into an angular displacement by a linear-to-rotational convertor 620. In FIG. 6, both the actuator 610 and the linear-to-rotational convertor 620 are placed outside a compressor body 630. However, in an alternative embodiment, the linear-to-rotational convertor 620 may be placed inside the compressor body 630. It is however desirable to lower the number of moving parts inside the compressor body 630, to lower likelihood of generating sparks, for example, due to accumulated electric charge thereof

Further, in FIG. 6, the actuator 610 is illustrated separate from the linear-to-rotational converter 620. However, in an alternative embodiment, the actuator 610 and components of the linear-to-rotational converter 620 may be mounted inside the same housing.

The linear displacement generated by the actuator 610 is transmitted via an actuator shaft 640 to a connector rod 650. The connector rod 650 has one end 652 attached to the actuator shaft 640 and an opposite end 654 attached to a portion 662 of a shaft 660. The shaft 660 is configured to rotate around an axis substantial parallel but at a significant distance from the portion 662. Due to the shape of the shaft 660, a relatively small linear displacement generated by the actuator 610 yields a significant angular displacement of the shaft 660. Inside the linear-to-rotational converter 620, the shaft 660 may be supported by bearings 670.

The shaft 660 is configured to penetrate inside the compressor body 630, where an end of the shaft 660 is connected to a moving part 690 of a rotating valve. The shaft 660 has a collar 664. A thrust bearing 680 is located between the collar 664 and a cover 632 of the compressor body 630. The thrust bearing 680 damps a force due to a pressure difference between fluid inside the compressor body 630 and ambient. Dynamic seals 682 located between the cover 632 and the shaft 660 prevent the fluid inside the compressor body 630 from leaking outside thereof.

Thus, due to the linear-to-rotational converter 620, the assembly 600 amplifies and converts a linear displacement generated by an (electric) actuator into an angular displacement capable to actuate a rotational valve in a reciprocating compressor.

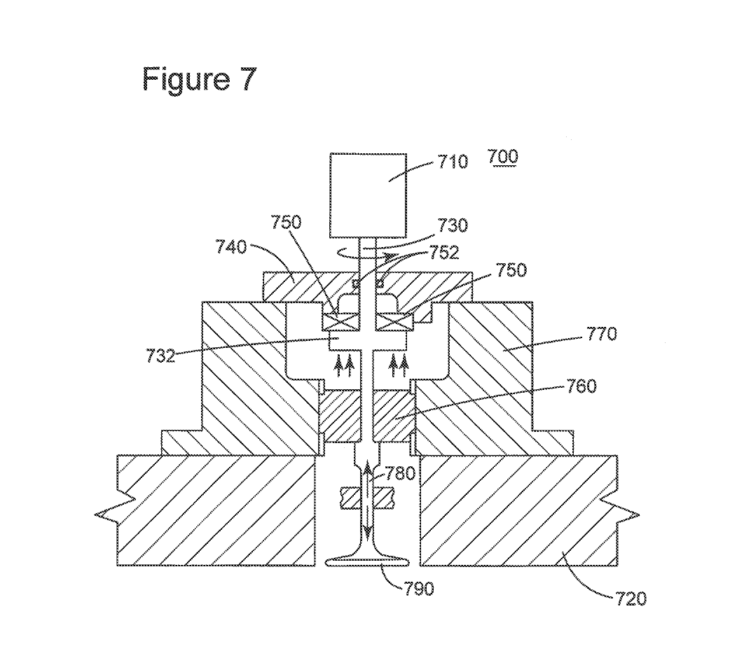

FIG. 7 is a schematic representation of a valve assembly 700, according to another exemplary embodiment. An actuator 710 located outside a compressor body 720 provides an angular displacement to a shaft 730. The shaft 730 penetrates through a cover 740 inside of the compressor body 720. The shaft 730, which has a collar 732, is pushed towards a thrust bearing 750 located between the collar 732 and the cover 740. The thrust bearing 750 damps a force due to a pressure difference between the fluid inside the compressor and ambient (where the actuator 710 is located). Dynamic seals 752 located between the cover 740 and the shaft 730 prevent the fluid inside the compressor body 720 from leaking outside thereof.

Inside the compressor body 730, the angular displacement of the shaft 730 is converted into a linear displacement by a screw-jack mechanism 760. The screw-jack mechanism 760 is fixedly attached to a screw-jack cover 770 located between the cover 740 and the cylinder body 720. The screw-jack mechanism 760 has an interior thread and the shaft 730 has an exterior thread, thereby, the angular displacement being converted into a linear displacement. For example, the screw-jack mechanism 760 may push an actuator shaft 780 attached to a valve closing member 790 of a linear valve (e.g., a poppet valve or a ring valve).

Thus, due to the screw-jack, the assembly 700 may be used to amplify force normally provided by an electric actuator and to convert an angular displacement into a linear displacement as needed to actuate a linear valve in a reciprocating compressor.

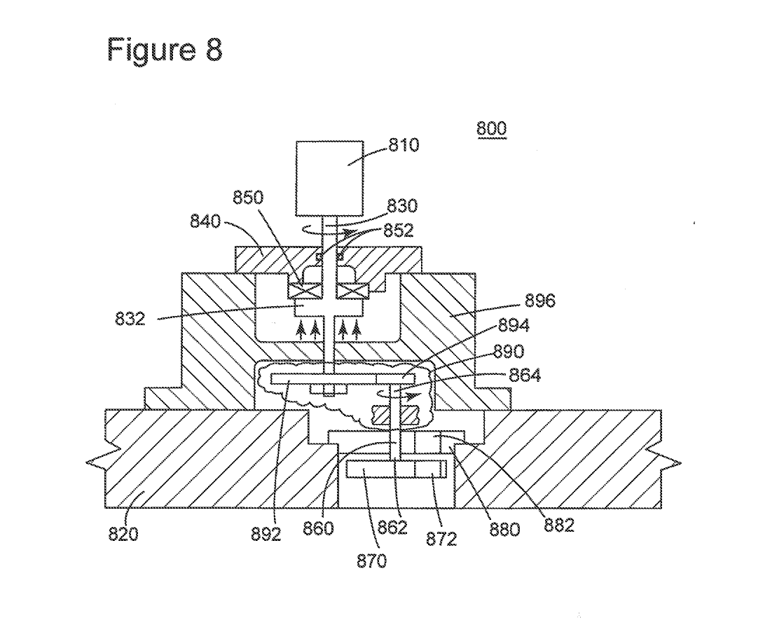

FIG. 8 is a schematic representation of a valve assembly 800, according to yet another exemplary embodiment. An actuator 810 located outside a compressor body 820 provides an angular displacement to a shaft 830. The shaft 830 penetrates inside the compressor body through a cover 840. The shaft 830 has a collar 832 with a diameter lager than the shaft's diameter along most of its length. A thrust bearing 850 located between the collar 832 and the cover 840 damps a force due to a pressure difference between fluid inside the compressor body 820 and ambient. Dynamic seals 852 located between the cover 840 and the shaft 830 prevent the fluid inside the compressor body 820 from leaking outside thereof.

Further, the valve assembly 800 includes an actuator shaft 860 at a first end 862 of which a valve closing member 870 of a rotary valve is attached. The rotary valve also includes a static seat 880. When, in a first position, an opening 882 through the valve seat 880 overlaps an opening 872 through the rotary valve 870 the valve is open. By rotating the valve closing member 870 of the rotary valve relative to the valve seat 880 in a second position, the openings 872 and 882 no longer overlap and the valve is closed.

Commercially available actuators provide relative small angular displacement (e.g., up to 40°). However, an efficient rotary valve needs a substantially wider angular opening (e.g.,) 120°). In order to achieve a rotation of the valve closing member 870 of the rotary valve relative to the valve seat 880 at least equal to this wider angular opening, the angular displacement provided by the actuator 810 is amplified by a multiplying gear mechanism 890. The multiplying gear mechanism 890 includes a first gear 892 attached to an end of the shaft 830, and a second gear 894 attached to a second end 864 of the actuator shaft 860 (the second end 864 being opposite to the first end 862). A second collar may be mounted or formed on the shaft 830 closer to the end of the shaft than the first gear 892. A radius of the first gear 892 is larger than the radius of the second gear 894, and since a circumferential displacement of the gears 892 and 894 is the same, the angular displacement of the gear 892 (which is equal to the angular displacement provided by the actuator 890) yields the wider angular displacement of the gear 894, which is needed for switching the valve closing member 870 of the rotary valve between the first position (e.g., close) and the second (e.g., open) position. A multiplying gear cover 896 located between the cover 840 and a wall of the compressor body 820 provides a support structure for the multiplying gear 890.

To summarize, FIGS. 4-8 illustrate valve assemblies useable in reciprocating compressor for oil and gas industry. These valve assemblies include actuators located outside the compressor body connected to a shaft penetrating inside the compressor body that transmits a (linear or angular) displacement provided by the actuator. A displacement transmission mechanism between the shaft and a valve closing member of a valve amplifies the displacement and/or a force associated with the displacement.

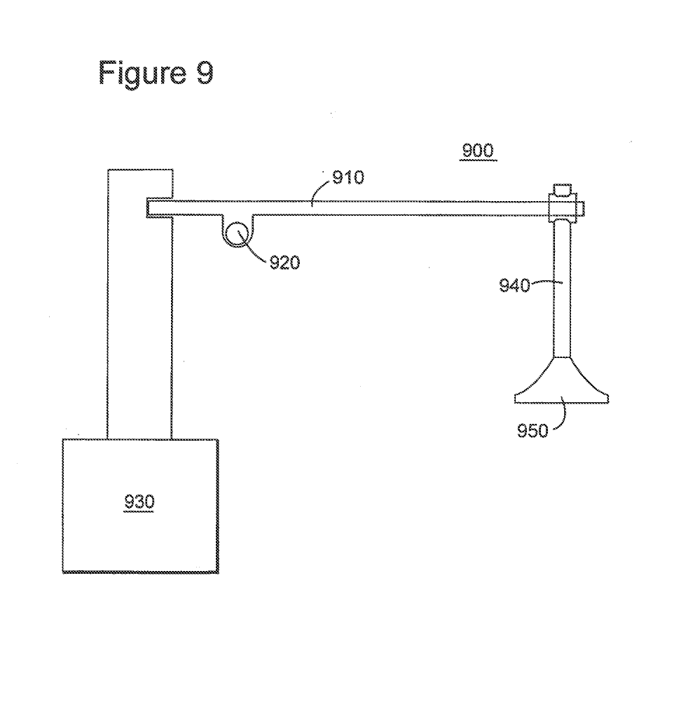

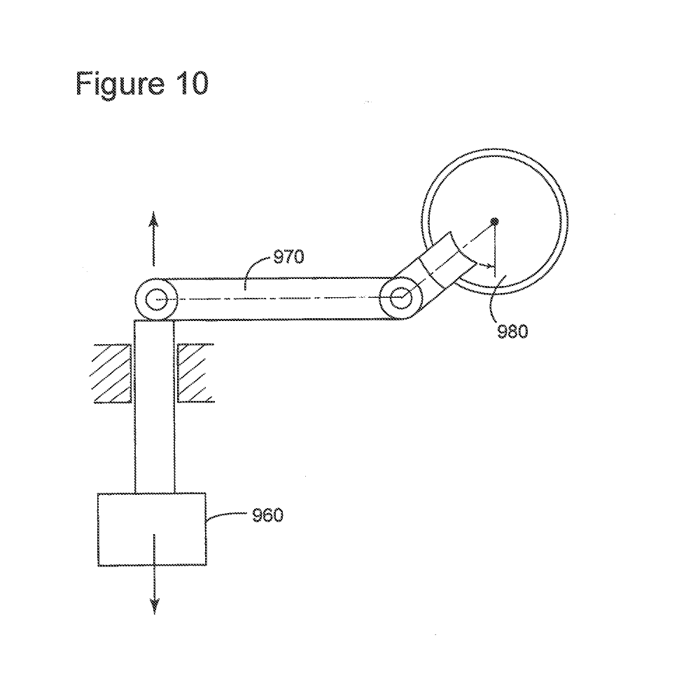

Unlike FIGS. 4-8 which illustrate complex valve assemblies, FIGS. 9 and 10 sketch mechanisms for amplifying displacement provided by actuators, mechanisms that may be located inside or outside the compressor body. In FIG. 9, a lever 910 configured to pivot around a fulcrum 920 amplifies a linear displacement provided by an actuator 930 to provide via an actuator shaft 940 enough linear displacement to actuate a valve closing member 950 of a linear valve (e.g., a poppet or ring valve) switching the valve between an open state and a close state.

In FIG. 10, a linear displacement provided by an actuator 960 is transmitted and converted into an angular displacement via a connecting rod 970 to actuate a valve closing member 980 of a rotating valve.

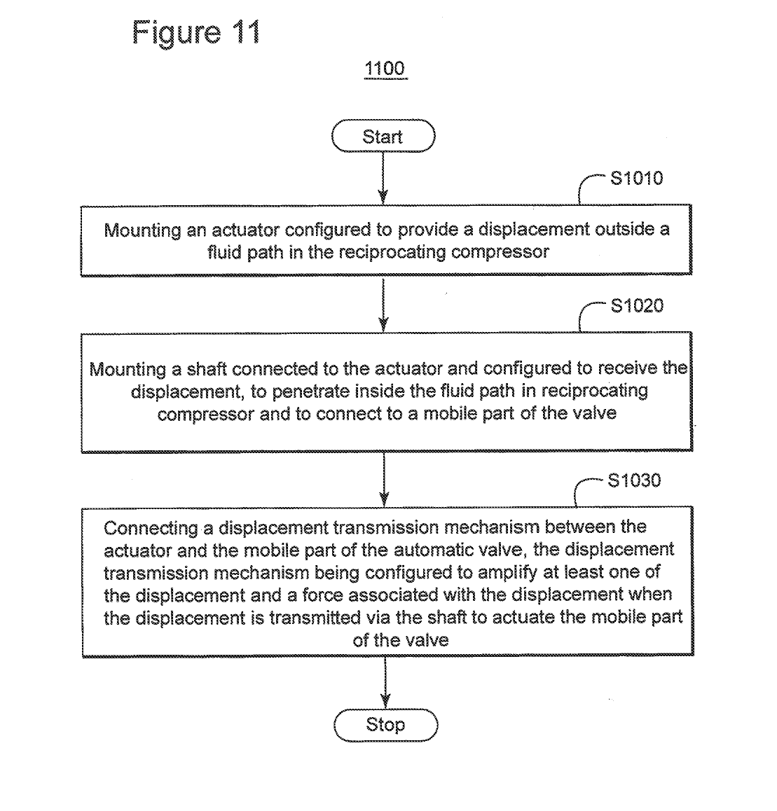

Existing reciprocating compressors having a cylinder in which fluid is compressed, the fluid flowing to or from the cylinder via an automatic valve configured to switch between an open state and a close state depending on a differential pressure across the valve, may be upgraded (retrofitted) to have the valve actuated. FIG. 11 is a flow chart illustrating a method 1000 for retrofitting a reciprocating compressor used in oil and gas industry according to an exemplary embodiment. The method 1000 includes mounting an actuator configured to provide a displacement, outside a fluid path in the reciprocating compressor, at S1010. The method 1000 further includes mounting a shaft connected to the actuator and configured to receive the displacement, to penetrate inside the fluid path in reciprocating compressor and to connect to a valve closing member of the valve, at S1020. Then, the method 1000 includes connecting a displacement transmission mechanism between the actuator and the valve closing member of the automatic valve, the displacement transmission mechanism being configured to amplify at least one of the displacement and a force associated with the displacement when the displacement is transmitted via the shaft to actuate the valve closing member of the valve, at S1030.

The disclosed exemplary embodiments provide valve assemblies for amplifying displacement and/or force between actuators and valves in reciprocating compressors used in oil and gas industry. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A valve assembly useable in a reciprocating compressor for oil and gas industry, the valve assembly comprising:
an actuator configured to provide a displacement;
a shaft connected to the actuator and configured to transmit the displacement from the actuator to a valve closing member of a valve of the reciprocating compressor; and
a displacement transmission mechanism connected to the shaft and configured to amplify the displacement and/or a force associated with the displacement provided by the actuator.

2. The valve assembly of claim 1, wherein
the actuator provides an angular displacement,
the actuator is located outside of a compressor body, and
the displacement transmission mechanism is located between the shaft and the valve closing member of the valve, inside the compressor body, and is further configured to convert the angular displacement into a linear displacement to actuate the valve closing member of the valve.

3. The valve assembly of claim 2, wherein:
the shaft is configured to rotate around a rotation axis, has a narrow cylindrical shape around the rotation axis for most of shaft's length, and has a U-shaped portion with a segment substantially parallel with and at a predetermined distance from the rotation axis, and
the displacement transmission mechanism comprises:
a connecting rod comprising a first end connected to the segment of the shaft that is substantially parallel with and at the predetermined distance from the rotation axis; and
an actuator shaft connected to a second end of the connecting rod and to the valve closing member of the valve.

4. The valve assembly of claim 2, wherein the displacement transmission mechanism comprises:
a screw-jack comprising a threaded channel inside which a threaded end of the shaft is inserted; and
an actuator shaft in contact to the screw-jack at a first end and having the valve closing member of the valve attached at a second end, which is opposite to the first end.

5. The valve assembly of claim 2, wherein the displacement transmission mechanism comprises:
a multiplying gear comprising at least a first gear attached to an end of the shaft inside the compressor body and a second gear intertwined with the first gear and having a smaller diameter than the first gear; and
an actuator shaft having the second gear attached to a first end of the actuator shaft and the valve closing member of the valve attached to a second end of the actuator shaft, the second end being opposite to the first end.

6. The valve assembly of claim 1, wherein:
the actuator provides a linear displacement,
the shaft is configured to rotate around a rotation axis, has a cylindrical shape around the rotation axis for most of the shaft's length, and has a U-shaped portion with a segment substantially parallel with and at a predetermined distance from the rotation axis, and
the displacement transmission mechanism comprises a linear-to-rotational converter comprising:
an actuator shaft connected to the actuator and receiving the linear displacement; and
a connecting rod comprising a first end connected to the actuator shaft and a second end connected to the segment of the shaft that is substantially parallel with and at the predetermined distance from the rotation axis.

7. A reciprocating compressor in oil and gas industry, the reciprocating compressor comprising:
a compressor body;
at least one valve connected to the compressor body; and
a valve assembly configured to actuate a valve closing member of the at least one valve, the valve assembly comprising:
an actuator configured to provide a displacement;
a shaft configured to transmit the displacement from the actuator to the valve closing member of the at least one valve; and
a displacement transmission mechanism connected to the shaft and configured to amplify the displacement and/or a force associated with the displacement provided by the actuator, to actuate the valve closing member of the at least one valve.

8. The reciprocating compressor of claim 7, wherein:
the actuator provides an angular displacement, the actuator is located outside of the compressor body, and the displacement transmission mechanism is located between the shaft and the valve closing member of the at least one valve,
the shaft is configured to rotate around a rotation axis, has a cylindrical shape around the rotation axis for most of shaft's length, and has a U-shaped portion with a segment substantially parallel with and at a predetermined distance from the rotation axis, and
the displacement transmission mechanism comprises a connecting rod comprising a first end connected to the segment of the shaft that is substantially parallel with and at the predetermined distance from the rotation axis, and an actuator shaft connected to a second end of the connecting rod and to the valve closing member of the valve.

9. The reciprocating compressor of claim 7, wherein the displacement transmission mechanism comprises:
a screw-jack comprising a threaded channel inside which a threaded end of the shaft is inserted; and
an actuator shaft in contact to the screw-jack at a first end and having the valve closing member of the valve attached at a second end, which is opposite to the first end.

10. A method of retrofitting a reciprocating compressor used in oil and gas industry and initially having an automatic valve, the method comprising:
mounting an actuator configured to provide a displacement, outside a fluid path in the reciprocating compressor;
mounting a shaft connected to the actuator and configured to receive the displacement, to penetrate inside the fluid path in the reciprocating compressor and to connect to a valve closing member of the automatic valve; and
connecting a displacement transmission mechanism between the actuator and the valve closing member of the automatic valve, the displacement transmission mechanism being configured to amplify the displacement and/or a force associated with the displacement when the displacement is transmitted via the shaft to actuate the valve closing member of the valve.
